(19) United States
(12) Patent Application Publication
(10) Pub. No.: US 2013/0141860 A1
(43) Pub. Date: Jun. 6, 2013

(54) FIXING MECHANISM FOR FIXING EXPANSION CARDS AND SERVER USING SAME

(71) Applicant: HAI-QING ZHOU, Shenzhen City (CN)

(72) Inventor: HAI-QING ZHOU, Shenzhen City (CN)

(21) Appl. No.: 13/628,461

(22) Filed: Sep. 27, 2012

(30) Foreign Application Priority Data
Dec. 2, 2011 (CN) 201110395130.6

(51) Int. Cl. F16B 2/06; G06F 1/16

(52) U.S. Cl. 361/679.32; 403/374.2

(57) ABSTRACT

A fixing mechanism for fixing expansion cards in place includes a fixing assembly, a clamping element opposite to the fixing assembly, and a connection element. A side of the clamping element away from the fixing assembly defines a recess for receiving the expansion card. The connection element is hinged to the fixing assembly and the clamping element. When the connection element is rotated relative to the fixing assembly and the clamping element, the clamping element is moved towards or away from the fixing assembly to adjust a distance between the fixing assembly and the clamping element.

### BACKGROUND

1. Technical Field

The disclosure generally relates to fixing mechanisms for fixing expansion cards and the mechanisms being used in servers.

2. Description of the Related Art

A server may include a case, a circuit board located in the case, and a peripheral component interconnect (PCI) expansion card such as video card or sound card. The circuit board defines PCI slots, and the expansion card includes PCI plugs corresponding to the PCI slots. The PCI plugs are located in the PCI slots, and then the expansion card is attached to the circuit board. However, if the expansion card suffers shock or impact, the expansion card is easily disconnected from the circuit board.

Therefore, there is room for improvement within the art.

### BRIEF DESCRIPTION OF THE DRAWINGS

Many aspects of an exemplary fixing mechanism and server can be better understood with reference to the following drawings. The components in the drawings are not necessarily drawn to scale, the emphasis instead being placed upon clearly illustrating the principles of the exemplary fixing mechanism and sever. Moreover, in the drawings, like reference numerals designate corresponding parts throughout the several views. Wherever possible, the same reference numbers are used throughout the drawings to refer to the same or like elements of an embodiment.

FIG. 1 is an exploded view of a fixing mechanism applied in a server, according to an exemplary embodiment.

FIG. 2 is an exploded view of the fixing mechanism shown in FIG. 1.

FIG. 3 is an assembled view of the server shown in FIG. 1.

FIG. 4 is a schematic view of the server in a state of use shown in FIG. 3.

FIG. 5 is an enlarged view of part V shown in FIG. 4.

### DETAILED DESCRIPTION

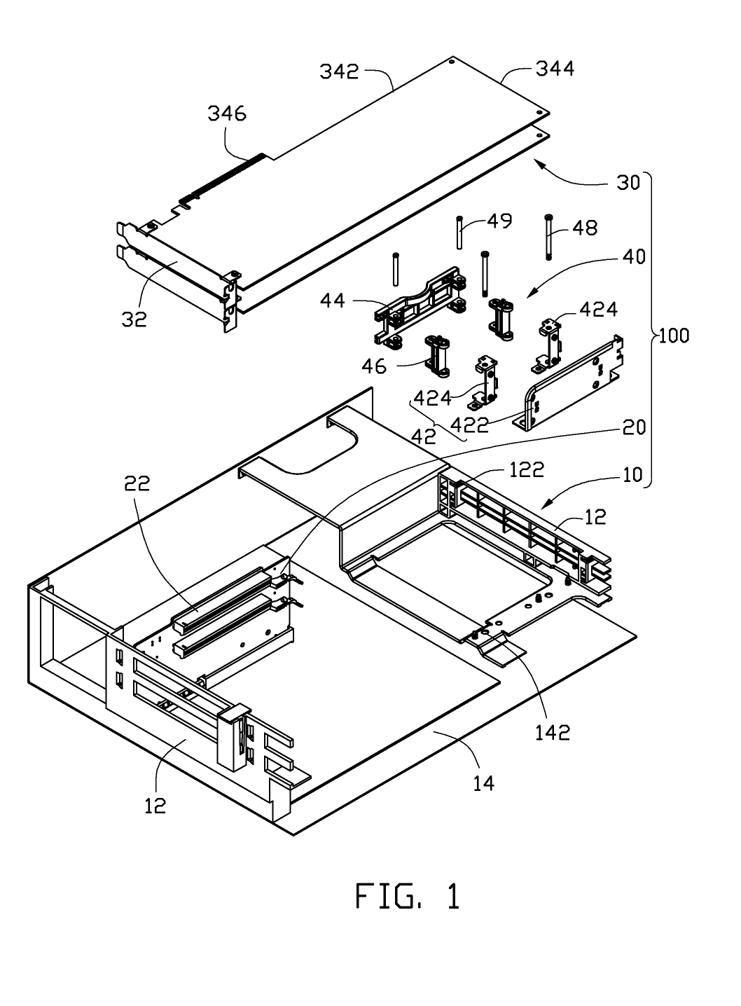

Referring to FIG. 1, a server 100 according to an exemplary embodiment is shown. The server 100 includes a case 10, a circuit board 20 located in the case 10, an expansion card module 30 mounted on the circuit board 20, and a fixing mechanism 40. The fixing mechanism 40 is attached to the case 10 and acts upon the expansion card module 30.

The case 10 includes two opposite sidewalls 12 and a bottom wall 14. The opposite sidewalls 12 are perpendicularly connected to the bottom wall 14. One sidewall 12 defines a plurality of cutouts 122 for engaging with the expansion card module 30. The bottom wall 14 defines two screw holes 142. The circuit board 20 includes a plurality of slots 22 for plugging in expansion cards.

The expansion card module 30 includes a fastening element 32 and two expansion cards 34. The two expansion cards 34 are parallel and are fixed to the connection element 32. Each expansion card 34 includes two opposite first flanges 342, two opposite second flanges 344, and a plug 346. The first flange 342 is longer than the second flange 344. The plug 346 extends from the first flange 342 and is adjacent to the second flange 344.

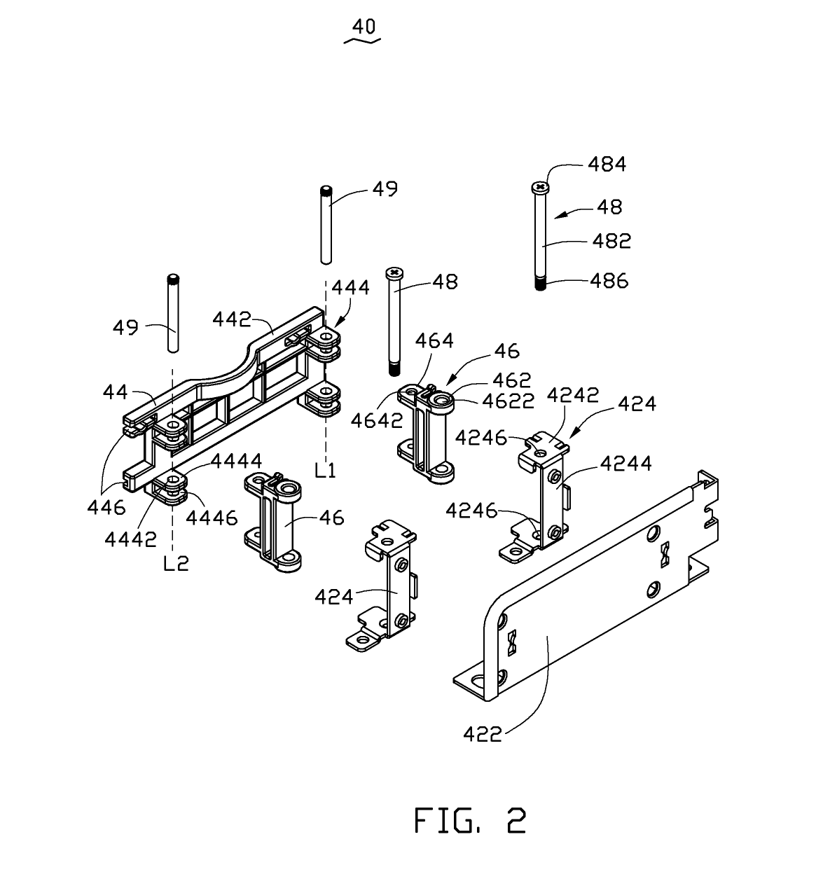

Also referring to FIG. 2, the fixing mechanism 40 includes a fixing assembly 42, a clamping element 44, two connection elements 46, two first shafts 48, and two second shafts 49. Each connection element 46 is hinged to the fixing assembly 42 through the first shaft 48 and each is hinged to the clamping element 44 through the second shaft 49.

The fixing assembly 42 includes a support plate 422 and two frames 424 located on the support plate 422. Each frame 424 includes a main portion 4244 and two opposite bent portions 4242 perpendicular to the main portion 4244. Each bent portion 4242 defines a through hole 4246. The two through holes 4246 are coaxial. The main portions 4244 are distanced from each other and are mounted on the support plate 422.

The clamping element 44 includes a base portion 442 and four joint sections 444 protruding from an inner surface of the base portion 442. A joint section 444 is located at each of the four corners of the base portion 442. An outer surface of the base portion 442 is opposite to the inner surface and defines two recesses 446. Each joint section 444 includes two opposite joint plates 4444, and a space 4446 is defined between the two joint plates 4444. Each joint plate 4444 defines a shaft hole 4442. A first axis L1 is defined through the four shaft holes 4442 which are aligned with each other. A second axis L2 is defined through the other four shaft holes 4442 which are also aligned with each other. The first axis L1 is parallel to the second axis L2.

Each connection element 46 includes two opposite protrusions 462 and two opposite fixing plates 464. The two protrusions 462 are located at one side of the connection element 46, and the two opposite fixing plates 464 are located at opposite sides of the connection element 46. Each protrusion 462 defines a first hinge hole 4622, and the two first hinge holes 4622 are coaxial. Each fixing plate 464 defines a second hinge hole 4642, and the two second hinge holes 4642 are coaxial.

The first shaft 48 includes a rod 482, an end portion 484 and a screw portion 486. The end portion 484 is located at an end of the rod 482, and the screw portion 486 is located at the other end of the rod 482. A cross sectional area of the end portion 484 is larger than a cross sectional area of the rod 482.

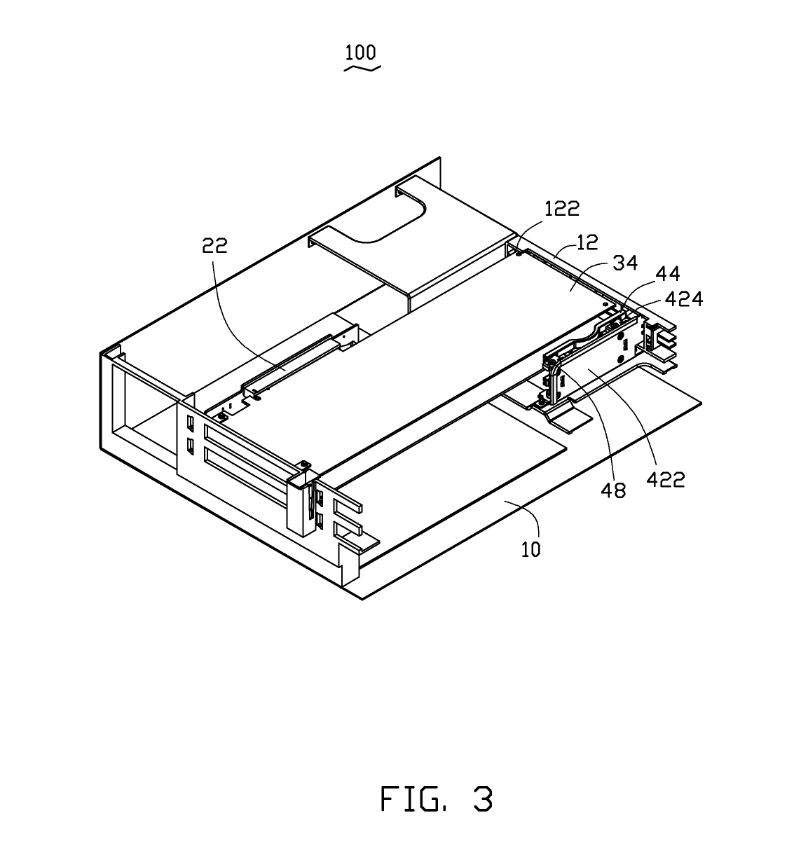

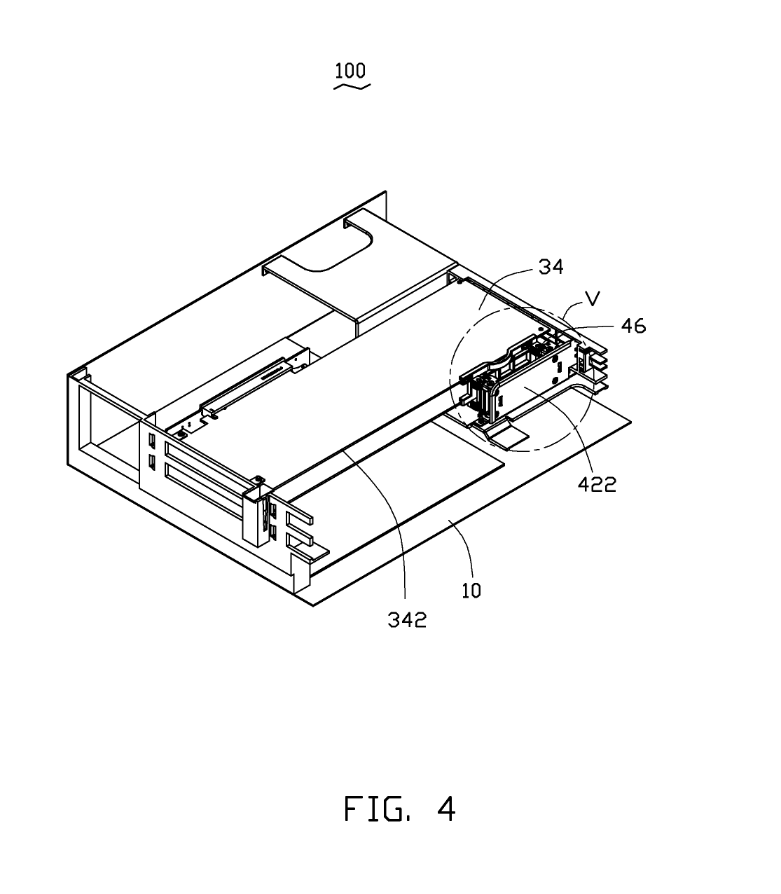

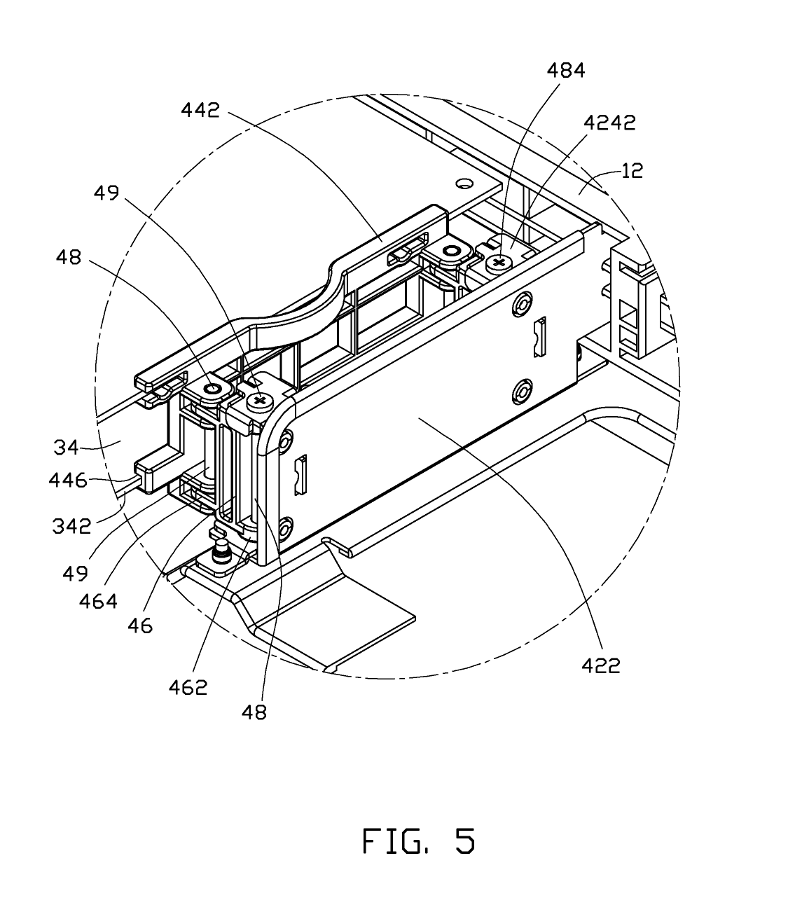

Referring to FIG. 3, FIG. 4, and FIG. 5, the server 100 is assembled as follows:

The two protrusions 462 of each connection element 46 are received between two bent portions 4242 of the frame 424, so that the first hinge holes 4622 are aligned with the through holes 4246. The first shaft 48 is inserted into the through holes 4246 and the first hinge holes 4622 until the end portion 484 abuts the bent portion 4242. The connection element 46 can be rotated relative to the frame 424 around the first shaft 48.

The two fixing plates 464 of the connection element 46 are received in the two spaces 4446 along the first axis L1 with the second hinge holes 4642 aligned with the shaft holes 4442. The two fixing plates 464 of the other connection element 46 are received in the two spaces 4446 along the second axis L2 with the second hinge holes 4642 aligned with the shaft holes 4442. One second shaft 49 is inserted into the second hinge holes 4642 and the shaft holes 4442 along the first axis L1, and the other second shaft 49 is inserted into the second hinge holes 4642 and the shaft holes 4442 along the second axis L2. The base portion 442 can be rotated relative to connection elements.

The screw portion 486 of each first shaft 48 is threadedly engaged with a screw hole 142 of the bottom wall 14. The plug 346 of each expansion card 34 engages with a slot 22 of the circuit board 20. A corner of the expansion card 34 is received in the cutout 122 of the sidewall 12. The clamping element 44 is pulled away from the support plate 422 until the first flange 342 of each expansion card 34 is received in a recess 446. The assembly process of the server 100 is thus completed.

The first flange 342 of the expansion card 34 is mounted to the circuit board 20 through the plug 346. The opposite first flange 342 of the expansion card 34 is mounted to the fixing mechanism 40. The expansion card 34 is locked in place in the server 100. The clamping element 44 can be pulled away from the support plate 422 to fasten the expansion card 34 in place or be pulled adjacent to the support plate 422 to allow the expansion card 34 to be removed. Thus, the clamping element 44 is easy to operate.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A fixing mechanism for fixing expansion cards, the fixing mechanism comprising:
a fixing assembly;
a clamping element opposite to the fixing assembly, a side of the clamping element away from the fixing assembly defining a recess for receiving the expansion card; and
a connection element hinged to the fixing assembly and the clamping element;
wherein when the connection element is rotated relative to the fixing assembly and the clamping element, the clamping element is moved towards or away from the fixing assembly to adjust a distance between the fixing assembly and the clamping element.

2. The fixing mechanism as claimed in claim 1, wherein the fixing mechanism further comprises a first shaft and a second shaft, the connection element is hinged to the fixing assembly through the first shaft and is hinged to the clamping element through the second shaft.

3. The fixing mechanism as claimed in claim 2, wherein the connection element comprises two opposite protrusions located at one side of the connection element and two opposite fixing plates located at an opposite side of the connection element, each protrusion defines a first hinge hole; each fixing plate defines a second hinge hole.

4. The fixing mechanism as claimed in claim 3, wherein the fixing assembly defines two coaxial through holes, the first shaft is inserted into the through holes and the first hinge holes.

5. The fixing mechanism as claimed in claim 4, wherein the clamping element defines a plurality of coaxial shaft holes, the second shaft is inserted into the shaft holes and the second hinge holes.

6. The fixing mechanism as claimed in claim 5, wherein the fixing assembly comprises a support plate and two frames located on the support plate, each frame comprises a main portion and two opposite bent portions perpendicular to the main portion, the main portions are spaced apart from each other and are mounted on the support plate.

7. The fixing mechanism as claimed in claim 6, wherein each bent portion defines a through hole.

8. The fixing mechanism as claimed in claim 7, wherein the clamping element comprises a base portion and four joint sections protruding from an inner surface of the base portion, an outer surface of the base portion opposite to the inner surface defines the recess.

9. The fixing mechanism as claimed in claim 8, wherein a joint sections is located at each of four corners of the base portion; each joint section includes two opposite joint plates, and a space is defined between the two joint plates, each joint plate defines a shaft hole.

10. The fixing mechanism as claimed in claim 9, wherein the first shaft includes a rod, an end portion and a screw portion; the end portion is located at an end of the rod, and the screw portion is located at the other end of the rod.

11. The fixing mechanism as claimed in claim 10, wherein a cross sectional area of the end portion is larger than a cross sectional area of the rod.

12. A server using an expansion card, comprising:
a case;
a circuit board located in the case; and
a fixing mechanism for fixing the expansion card, the fixing mechanism comprising:
a fixing assembly;
a clamping element opposite to the fixing assembly, a side of the clamping element away from the fixing assembly defining a recess for receiving the expansion card; and
a connection element hinged to the fixing assembly and the clamping element;
wherein when the connection element is rotated relative to the fixing assembly and the clamping element, the clamping element is moved towards or away from the fixing assembly to adjust a distance between the fixing assembly and the clamping element.

13. The server as claimed in claim 12, wherein the circuit board comprises a slot; the expansion card comprises two opposite flanges, a plug is extended from one flange and is engaged with the slot, and the other flange is received in the recess.

14. The server as claimed in claim 12, wherein the fixing mechanism further comprises a first shaft and a second shaft, the connection element is hinged to the fixing assembly through the first shaft and is hinged to the clamping element through the second shaft.

15. The server as claimed in claim 14, wherein the connection element comprises two opposite protrusions located at one side of the connection element and two opposite fixing plates located at an opposite side of the connection element, each protrusion defines a first hinge hole; each fixing plate defines a second hinge hole.

16. The server as claimed in claim 15, wherein the fixing assembly defines two coaxial through holes, the first shaft is inserted into the through holes and the first hinge holes.

17. The server as claimed in claim 16, wherein the clamping element defines a plurality of coaxial shaft holes, the second shaft is inserted into the shaft holes and the second hinge holes.

18. The server as claimed in claim 17, wherein the fixing assembly comprises a support plate and two frames located on the support plate, each frame comprises a main portion and two opposite bent portions perpendicular to the main portion, the main portions are spaced apart from each other and are mounted on the support plate; each bent portion defines a through hole.

19. The server as claimed in claim 18, wherein the clamping element comprises a base portion and four joint sections protruding from an inner surface of the base portion, an outer surface of the base portion opposite to the inner surface defines the recess.

20. The server as claimed in claim 19, wherein a joint sections is located at each of four corners of the base portion; each joint section includes two opposite joint plates, and a space is defined between the two joint plates, each joint plate defines a shaft hole.
